(19) United States
(12) Patent Application Publication
(10) Pub. No.: US 2004/0225877 A1
(43) Pub. Date: Nov. 11, 2004

(54) Method and system for protecting computer system from malicious software operation

(76) Inventor: Zezhen Huang, Canton, MA (US)

Correspondence Address: Zezhen Huang, 5 Beaver Brook Road, Canton, MA, 02021, US

(21) Appl. No.: 10/792,506

(22) Filed: Mar. 3, 2004

Related U.S. Application Data
(60) Provisional application No. 60/469,113, filed on May 9, 2003.

(51) Int. Cl. G06F 11/30

(52) U.S. Cl. 713/100; 713/200

(57) ABSTRACT

A method and system for protecting a computer system from malicious software operations in real-time is disclosed. The security system combines system and user activity information to derive a user initiation attribute indicating whether or not a system operation is initiated by a computer user, and stop secrete malicious software operations that are not initiated by a computer user. The security system incorporates a plurality of attributes to support flexible security policy design, warn about potentially damaging operations by Trojan programs, and dynamically create security policies to allow trusted programs to perform trusted operations.

### CROSS REFERENCE TO RELATED APPLICATIONS

This application claims the benefit of PPA application No. 60/469,113, filed May 9, 2003 by the present inventor.

### FIELD OF INVENTION

The present invention generally relates to the field of computer security. More specifically, the present invention relates to intrusion detection and control of computer virus, Trojan Horse program, or any malicious software.

### INTRODUCTION

Malicious software operation can cause great damage such as deleting files, stealing personal information, and clogging the networks. Malicious software operations can be generated by computer virus, Trojan horse program, spy program and unauthorized network intrusion. A computer virus is executable code that, when run by someone, infects or attaches itself to other executable code in a computer in an effort to cause damage and reproduce itself. A Trojan horse program performs some undesired yet intended action while, or in addition to, pretending to do something else. For example, a Trojan horse program may present itself as a login program—collecting accounts and passwords by prompting for this information just like a normal login program does and secretly sending the information to a remote computer. A spy program, also referred to as spyware, is similar to a Trojan horse program that performs malicious operation, but often works secretly in the background. A spy program may be installed unintentionally when a computer user downloads files from the Internet, by unauthorized network intrusion or by unauthorized user. Unauthorized network intrusion refers to computer hacking by an unauthorized user (referred to as hacker) through the computer network. When the hacker breaks into a computer, the hacker may take control of the computer and perform malicious operations, including installing computer virus or Trojan horse program. Computer hacking typically exploits security holes in networks or software programs, or uses stolen user name and password.

There are existing technologies to prevent or detect malicious software operation on a computer. One technology is anti-virus software that scans files in a computer or a network to detect and remove any known computer virus. The problem with anti-virus software is that it cannot detect new virus which identity has not been included in the virus database. Nowadays, new virus can propagate over the Internet in minutes or hours while virus database is typically updated in days or weeks, rendering anti-virus software ineffective. Anti-virus software also cannot prevent malicious operation by computer hacking. One popular technology against computer hacking is firewall, which protects a private network by blocking certain network connections initiated by outside users except for public websites. Firewall, however, cannot stop hacking by exploiting weakness in the computer and network systems, using Trojan horse or virus sent over emails and legally passing the firewall. Two popular technologies against computer hacking is network intrusion detection system (NIDS) and host-based intrusion detection (HIDS). NIDS analyzes network traffic to detect abnormal traffic based on statistics, or common hacking signatures such as DoS (denial of service) attack, TCP/UDP port scan, ping sweeps, DNS zone transfers, e-mail reconnaissance, OS identification, account scans, etc. HIDS is software running on a computer to detect anomalous activity. HIDS monitors system, event, and security log files generated in the operating system to look for attack signatures, specific patterns that usually indicate malicious intent. Both NIDS and HIDS could prevent malicious operations in real-time. The difficulties with NIDS and HIDS lie in distinguishing normal and abnormal activities. They both are heavily dependant on expert knowledge about anomalous activity or attack signatures. There are always new software deployed, new security holes discovered and new attack techniques developed, and almost unlimited possibilities of activity patterns, the success of NIDS and HIDS is limited. They often generate too many false alarms or overlook the real hacking and malicious operation. They are also powerless in preventing viruses transmitted through emails or security holes.

The present invention provides novel security method and system. It utilizes both system information and user information and analyzes their associations to detect and prevent malicious software operation for personal computer, personal assistant device (PDA), mobile handset, and any computing device operated by a person (in the following, personal computer refers to all these devices). The present invention exploits a critical computer usage pattern: in personal computers, most normal software operations are initiated by the computer user directly through a keyboard, a mouse, or any peripheral device connected to the computer. On the other hand, malicious software operations, either by computer virus or computer hacking, are performed secretly without direct user initiation and often without user notice. According to the present invention, every potentially damaging system activity such as writing file, deleting file, sending email, and other network communication occurred in the computer is captured and determined in real-time whether or not the system activity is initiated by the computer user, the user initiation information is then combined with other attributes about the system activity and the associated software program to determine what security actions should be taken. If a potentially damaging system activity is not initiated by the computer user, it can be stopped before being carried out. This would prevent many viruses and hackers from secretly conducting operations such as deleting files and sending data to other computers. On some computers however, some normal software operations may automatically start without direct user initiation. For example, an email program may be configured to automatically retrieve emails from mail server every 10 minutes. Typically, such software operations and the number of programs performing the operations are well known, and therefore it is much easier to define rules referred to as security policies to permit these software operations even without user initiation. On the other hand, a Trojan horse program may present a misleading user interface and induce the user to operate on it, and once the user clicks on some buttons, it could immediately perform malicious operations that appear to be initiated by the user and avoid detection by the security system. In the present invention, the security system would detect whether a program has initiated a new potentially damaging operation that it has not done before even the operation appears to be initiated by the user, warn the user about the operation, and allow the user to stop or grant the operation. Once the user grants the operation, a new security policy can be added to allow the same or similar operations initiated by the user with the same program in the future without further warning. The present invention incorporates a plurality of attributes to support flexible security policy design including those described above.

User initiation can be determined by recording user activities generated in any of the computer's peripheral devices such as keyboard, mouse, screen touch, and analyzing the associations between user activities and system activities. For example, a system activity can be considered as initiated by a user if the software program generating the system activity also receives user activities in a time period (referred to as time window) preceding the system activity. And if a software program generating a system activity has no user interface for receiving user activity, or there is not any user activity detected in the computer in a time window preceding the system activity, the system activity is not initiated by a user. User initiation information may also be provided by the computer operating systems that keep track of relationships between system activities, software programs, and user activities.

In the preferred embodiment of the present invention, the user initiation attribute is combined with other attributes about the system activity and the associated software program for determining security actions. Incorporating with other attributes can achieve higher flexibility and reliability. These attributes may comprise identity of the program, identity of the software vendor, identities of the computer entities associated with the system activity, and the environmental parameters where the system activity occurs. For example, a trusted software program can be allowed to perform certain operations that had been granted by the user even without direct user initiation. In the preferred embodiment of the present invention, rules referred to as security policies are used for matching a plurality of attributes including the user initiation attribute derived from a system activity, and the security action specified by the best matched security policy is taken against the system activity.

### SUMMARY OF THE INVENTION

The present invention provides a security method and system to protect personal computers from malicious software operation. Personal computers refer to any computing devices, including, but not limited to desktop personal computers, notebook computers, personal assistant devices (PDA), combined cellular phone handsets and PDA. In the preferred embodiment, the security system prevents malicious software operations by performing the following steps in real-time: intercepting system activities in the computer system, recording user activities generated in any of the user controlled peripheral devices connected to the computer; evaluating association between a system activity and any user activities to determine whether or not the system activity is initiated by the computer user (referred to as the user initiation attribute); deriving additional attributes from the system activity and the associated software program; searching in a policy database for the best matched security policy given the set of attributes derived in the above steps, and taking security actions specified by the best matched security policy regarding the system activity.

A security policy comprises at least a security action and a plurality of attribute specifications. An attribute specification defines matching values for an attribute. If the attribute specifications of a security policy are found to best match the given set of attributes, the security system executes the security action specified by the security policy. A system activity is a software or hardware operation to be carried out by the operating system on behalf of a software program and may affect one or more computer entities. A system activity can be represented by a data structure comprising a command code specifying an operation (for example, “open file”), identity of the software program (for example, “Microsoft Word” program) generating or receiving the system activity, and identities of the computer entities (for example, the file name to be opened) affected by the operation. A computer entity could be a file, a file directory, a network connection, a software or hardware interface, a system registry key, a program, a command, etc. Possible operations include: opening file, reading data from file, writing data to file, deleting file, setting registry key value, requesting a network connection, accepting a network connection, sending data or receiving data over a network connection, executing a command, executing a program, etc. An attribute is a parameter about the system activity or the associated software program. Possible attributes include: user initiation attribute specifying whether or not the system activity is initiated by the computer user; command code representing the operation; identity of the software program; identity of the vendor creating the software program; identities of the computer entities affected by the system activity.

After obtaining a set of attributes in real-time, the security system searches for a security policy matching the given set of attributes, and takes one or more security actions specified in the security policy. Note that a security policy may not necessarily comprise specifications of all the attributes presented. If an attribute specification is omitted, its specification is considered to include all values. Possible security actions may include: passing through the system activity; stopping the system activity; stopping the executing program; writing a message in a log file; popping up a window displaying warning message and one or more actions to be chosen by the computer user and carrying out the action chosen by the user; sending an email to an administrator or the computer user, etc. The warning message in the popup window may comprise information about the system activity and the associated software program and software vendor, and other instructions for the user.

In the preferred embodiment of the present invention, the policy database initially contains a set of security policies to stop and warn potentially damaging operations that are carried out without user initiation, warn the user of potentially damaging operations performed by new programs, while allow well known operations performed by well known software programs regardless of user initiation. The computer user can modify, delete, or add any security policy at anytime.

The security policy database may comprise one or more files and may reside locally in the computer, or remotely in a computer server. In a corporate environment where security policies can be set centrally and deployed company wide, a policy server maybe desirable as it can be centrally managed and shared by multiple computers. The security policies may also be comprised in an electronic document that is digitally signed with a digital certificate and sent to the security system. When digitally signed with a certificate, the security policies and the author(s) of the security policies can be authenticated. A public encryption key comprised in the digital certificate can also be used to encrypt data generated by the security system that can be decrypted only by the certificate holder having the private key.

Note that in this description, database refers to any data collection stored in any memory storage, it can be custom-created files or a commercial database stored in hard-drive, disk, flash-memory, or a data buffer stored in the computer's random access memory (RAM).

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is a diagram showing some key components of a personal computer comprising one or more user controlled peripheral device;

FIG. 2 is a diagram of the security system in accordance with one embodiment of the present invention;

FIG. 3 depicts some system and user activity hooks;

FIG. 4 is a diagram depicting the flowchart of a user association procedure in one embodiment of the present invention;

FIG. 5 is a diagram depicting the flowchart of a user association procedure in another embodiment of the present invention;

For the most part, and as will be apparent when referring to the figures, when an item is used unchanged in more than one figure, it is identified by the same alphanumeric reference indicator in the various figures in which it is presented.

### DETAILED DESCRIPTION OF THE PREFERRED EMBODIMENTS

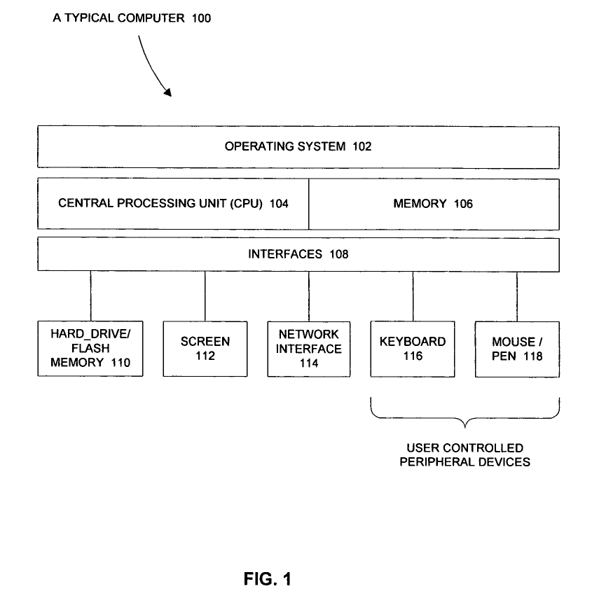

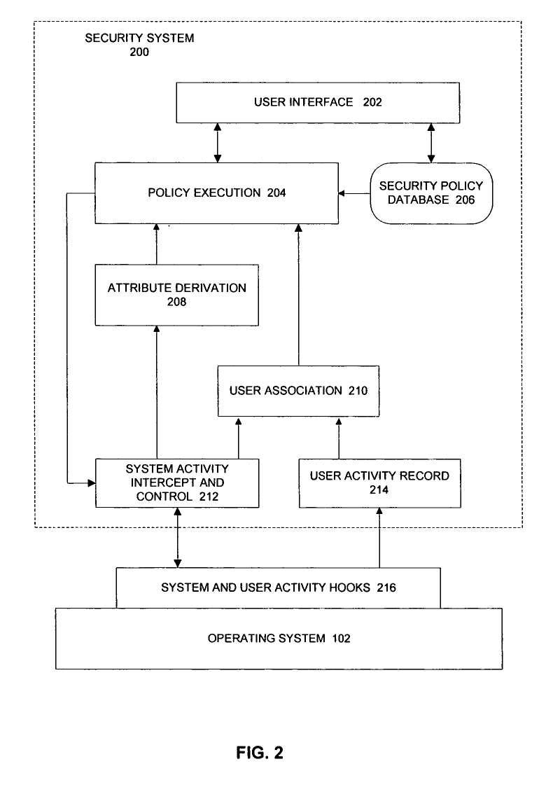

FIG. 1 shows a typical computer 100 that comprises a central processor unit (CPU) 104 for executing software programs, a memory unit 106 for storing data and software program, an operating system 102 that manages the software and hardware resources and provides services to software programs, a hard-drive or flash memory 110 for storing software programs and data permanently, and some peripheral devices such as a monitor screen 112, a network interface 114, one or more user controlled peripheral devices such as a keyboard 116, a mouse or a pen 118. As shown in FIG. 2, the security system 200 of the present invention is a software system executing in the computer 100 to detect and control malicious software operations.

The security system 200 comprises a group of modules: a system activity intercept and control module 212 that intercepts system activities using one or more system activity hooks 216; a user activity record module 214 that records user activities using one or more user activity hooks 216; a user association module 210 that analyzes the associations between a system activity and user activities to determine the user initiation attribute indicating whether or not the system activity is initiated by the computer user; an attribute derivation module 208 that derives additional attributes from a system activity and the associated software program; a policy execution module 204 that receives a set of attributes, searches in a security policy database 206 for a security policy that best matches the given set of attributes, and takes security action defined by the best matched security policy. The policy execution module 204 sends a message to the system activity intercept and control module 212 to either pass through or stop the system activity.

A system activity is a software or hardware operation to be carried out by the operating system on behalf of a software program and may affect one or more computer entities. A system activity can be represented by a data structure comprising information about the system activity and related software program. Following are some useful attributes that can be derived from the system activity:

1. A command code identifying the operation, such as opening file, deleting file, requesting a network connection, accepting a network connection, sending data and receiving data over a network connection, starting program, starting command, setting registry value.

2. One or more identities of the computer entities associated with the operation, such as the file name, network connection identifier;

3. Identity of the executing software program generating or receiving the system activity. The identity could be the program name, or a hash value generated from the program file, or a digital signature signed on the program file, or the combination of program name and hash value;

4. Identity of the vendor creating the software program. The identity could be the corporation name, which could be comprised in the program file, or in a digital certificate used to verify the digital signature signed on the program file.

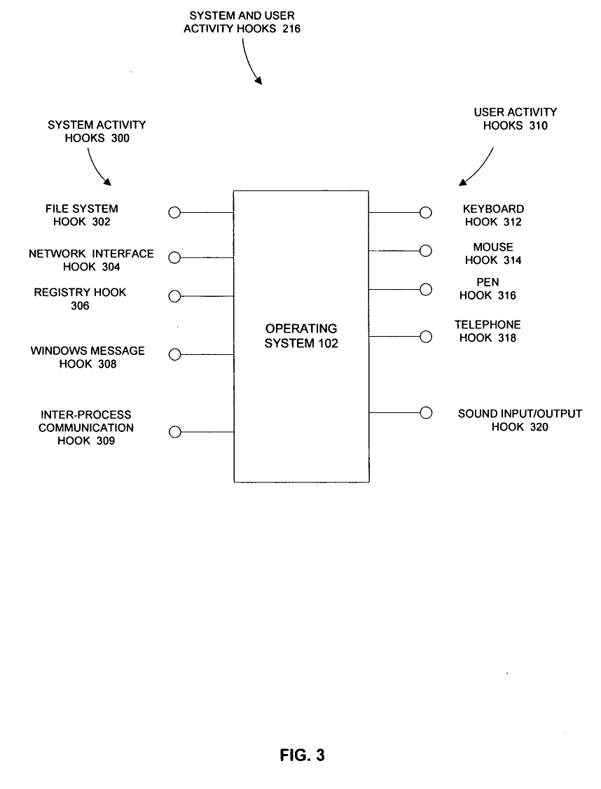

When the computer operating system receives a system activity, it normally carries out the specified operation with successful or unsuccessful result. The system activity intercept and control module intercepts a system activity when it is received by the operating system but before it is carried out, and will hold the system activity until it receives instruction from the policy execution module to either stop or pass through the system activity. A user activity is an event generated in a user controlled peripheral device when the computer user operates the peripheral device, such as pressing a key in the keyboard, clicking a button in the mouse. A user activity can be represented by a data structure comprising the device input information. The data structure is received by the operating system and sent to the active software program waiting for user inputs. Examples of user activities include keystrokes, mouse clicks, screen touches, etc. The user activity record module can record user activities at two different levels: at the user (or program) level when they are received by the active program, or at the driver level when they are received by the operating system. It is desirable to record user activities at the driver level such that simulated user activities generated by software program will not be counted. Many well-known computer operating systems such as Microsoft Windows and UNIX provide “hook” (or referred to as “filter”) mechanism for an executing software program to intercept a system or user activity, as indicated by the system and user activity hooks module. As shown in FIG. 3, the operating system 102 provides different types of system activity hooks 300 and user activity hooks 310, each type of hook is associated with a specific device. Examples of hooks include file system filter 302 at the driver level for intercepting file system activities, network interface filter 304 at the driver level for intercepting network activities, registry hook 306 at the driver level for intercepting setting registry key value, keyboard hook 312 at user level or driver level for recording keystrokes, mouse hook 314 at user level or driver level for recording mouse movement and clicks. The security system can install one or more hooks according to what types of system and user activities are to be intercepted and recorded. Typically, the operating system offers multiple methods for implementing a hook, some can be implemented at user level as a program “plug-in” (or DLL—dynamic link library) module, and others can be implemented at the driver (or kernel) level as a filter or through function interceptor in a library. Details about the methods of implementation can be found in public programming documentations.

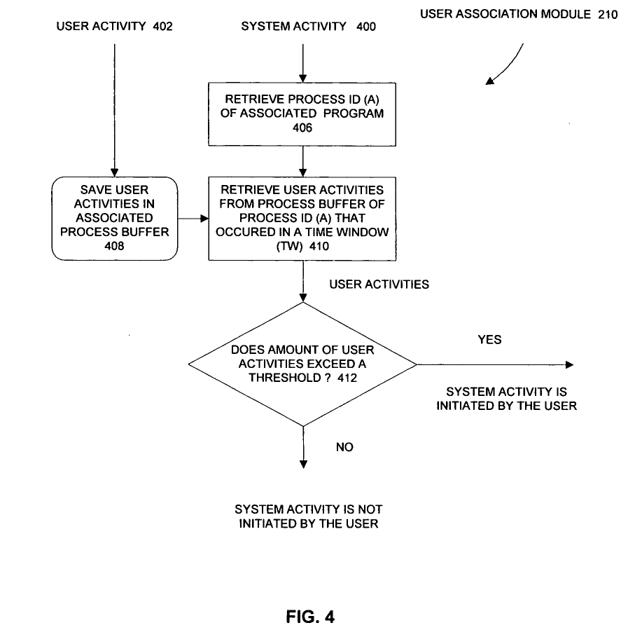

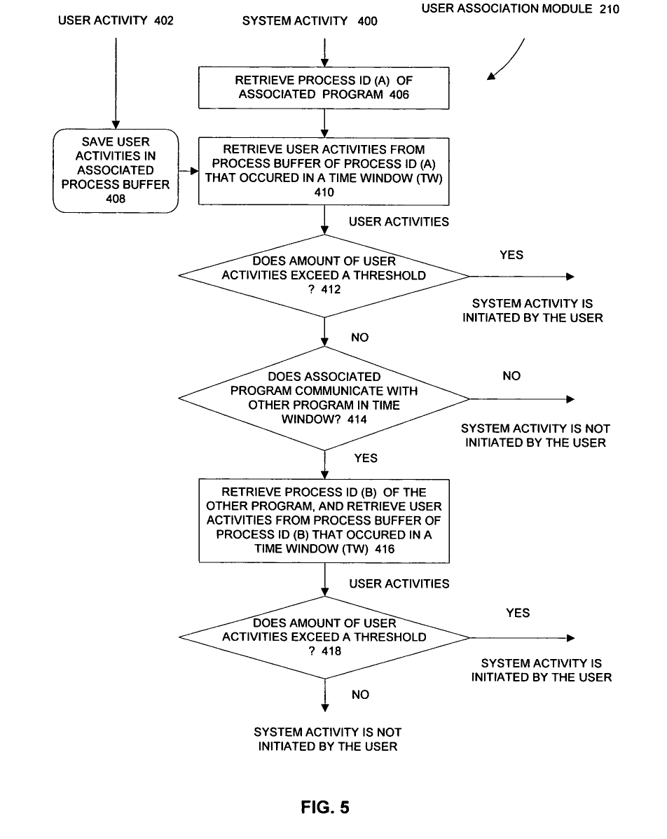

The user association module receives both system activities and user activities. It derives a user initiation attribute for a system activity. The user initiation attribute is set to TRUE if the system activity is initiated by the computer user, and FALSE if it is not initiated by the computer user. This attribute is derived by analyzing the association between a system activity and any of the user activities occurred in a time window preceding the system activity. Depending on the system environment and security requirement, there can be different methods for determining the association. In a simple condition, if the software program generating a system activity has no user interface for receiving user activities, the user initiation attribute can be set to FALSE for the system activity. This condition applies to most computer viruses as they usually operate in background and have no user interface. Most operating systems provide functions to check if an executing software program has user interface or not. In another simple condition, if there is not any user activity detected in the computer in a time window preceding a system activity, the user initiation attribute can be set to FALSE. This condition often applies to computer hacking conducted in off-office hours when the computer is idle. In general conditions, the following method can be used to determine the user initiation attribute: if the program generating a system activity has received user activities in a time window preceding the system activity (or has communicated with another program that received user activities in a time window preceding the system activity), the user initiation attribute is set to TRUE; otherwise, if the program has not received any user activity, the user initiation attribute is set to FALSE. FIG. 4 shows this method in details. FIG. 4 is a flowchart of determining association between a system activity and any user activities based on process relationship. A process represents an active software program in the computer system. With reference to FIG. 4, the user association module 210 maintains a buffer for each process, referred to as process buffer that is referenced by a unique process Id. For each user activity 402 received, the user association module 210 retrieves the process Id of the program receiving the user activity 402 and logs the user activity in the associated process buffer as shown in step 408. For each system activity 400 received, the user association module 210 retrieves the process Id (A) of the associated program, retrieves the process buffer referenced by the process Id (A) and retrieves a group of user activities from the process buffer that occurred within a time window (TW) preceding the system activity as shown in step 410. Typically, when a user initiates an operation by typing a few keystrokes or clicking the mouse, one or more system activities are generated in a short time window to carry out the operation. And therefore as shown in step 412, if within the time window, the number of user activities is none zero, the system activity can be considered as being initiated by the user and the user initiation attribute is set to TRUE; if the number of user activities is zero, the system activity is not initiated by the user and the user initiation attribute is set to FALSE. The time window length can be set by the system or the user, it can also be set dynamically by the system according to the software program. Note that according to the rule illustrated in FIG. 4, it may sufficient to account the number of user activities in time slots, instead of logging the content of every user activities in the process buffer. FIG. 5 shows another flowchart where inter-program communications are also considered in user association. In some software design, there could be more than one programs involved in one application. For example, in client-server architecture, the client and server run independently in their own processes, the client initiates request by sending message to the server, the server performs the function and sends message with result to the client. Typically, the server runs in the background, while the client interacts with the user. The user initiates an operation through the client user interface, but it is the server that performs the operation. Therefore, to determine whether or not an operation performed by the server is initiated by the user, it is necessary to take into account of the client-server communications. With reference to FIG. 5, the user association module 210 uses the same flowchart as shown in FIG. 4 to determine whether or not the program associated with a system activity has received user activities in a time window; if the associated program has not received user activities, in step 414 it further determines whether or not the associated program has communicated with any other program in the time window; if the associated program communicates with the other program, in steps 416 and 418, it determines whether or not the other program has received user activities in the time window; and the system activity is determined to be initiated by the user if the associated program communicates with the other program that received user activities in the time window. Depending on applications and security requirement, other user association rules can be used. For example, the content of user activities rather than just the amount of user activities can be used to determine the association.

Besides the user initiation attribute, the attribute derivation module 208 in FIG. 2 derives additional attributes from a system activity and its associated software program to provide more information for finding a security policy. Adding additional attributes allow flexible security policy design. The selection of additional attributes depends on system and policy requirement. Following are some additional attributes that can be used:

1. Command code attribute. This attribute takes an integer value identifying one of the following command codes:

a) OPEN_FILE for opening an existing file or file directory;

b) CREATE_FILE for creating a new file or file directory;

c) READ_FILE for reading data from a file;

d) WRITE_FILE for writing data to a file;

e) DELETE_FILE for deleting a file or file directory;

f) RENAME_FILE for renaming a file or file directory;

g) ACCEPT_CONNECTION for accepting a network connection;

h) REQUEST_CONNECTION for requesting a network connection;

i) SEND_DATA for sending data over a network connection;

j) RECEIVE_DATA for receiving data over a network connection;

k) EXECUTE_COMMAND for executing a system command;

l) START_PROGRAM for starting a software program;

m) SET_REGISTRY for setting a registry key value.

The above command codes describe most system activities that are crucial to computer security. The command code attribute allows policy design to treat different operations differently.

2. One or more computer entity attributes. Each computer entity attribute is an identity specifying a computer entity that is associated with the system activity. For a system activity, the number of computer entity attributes and the meaning of each attribute are dependant on the command code. If the command code is OPEN_FILE, CREATE_FILE, READ_FILE, WRITE_FILE, DELETE_FILE, there is one entity attribute and it is a file name (or directory name as directory is a special file), which may contain ‘wildcard’ identifying a group of files; if the command code is RENAME_FILE, there are two entity attributes for the source file name and the target file name, respectively; if the command code is ACCEPT_CONNECTION, REQUEST_CONNECTION, SEND_DATA, RECEIVE_DATA, there is one entity attribute specifying the network connection that typically comprises {protocol-Id; source-address, source-port-number; destination-address; destination-port-number}; if the command code is EXECUTE_COMMAND, there is one entity attribute specifying the command name; if the command code is START_PROGRAM, there is one entity attribute specifying the program file name to be started, if the command code is SET_REGISTRY, there is one entity attribute specifying the registry key and value. The computer entity attribute allows policy design to treat different computer entities differently.

3. Program identity attribute that uniquely identifies the software program associated with the system activity. Program identity attribute could be the name of the program, or other identity such as a hash value generated from the program file that uniquely identifies the program, or the combination of both. The program name or program file name can be obtained from operating system provided functions. If a hash value is used, it could be stored in a table associated with the program file, or comprised in a digital signature signed on the program file. The program identity attribute allows policy design to apply special treatments for different programs.

4. Software vendor attribute that identifies the vendor of the software program. It could be the name of the company. A typical software program file contains the company name and the version number. The name could also be comprised in a digital certificate used for verifying the digital signature signed on the program file. The software vendor attribute allows policy design to trust certain vendors and allow certain operations for programs created by them that would otherwise not be allowed for other programs. It also provides information for the user to make a judgment on whether to just the program. The aforementioned additional attributes are optional; other new attributes can be added as well. Together with the user initiation attribute, all attributes can be arranged in a data array ATTRIBUTE[I], 1=1, 2, 3, . . . N, where the index I identifies the attribute and ATTRIBUTE[I] stores the attribute value. For example, I=1 for User initiation attribute; I=2 for Command code attribute; I=3 for Program identity attribute; I=4 for Software vendor attribute; I=5 for the first computer entity attribute; I=6 for the second computer entity attribute, and so on. The policy execution module 204 in FIG. 2 uses the attribute array to search for a security policy.

A security policy comprises one or more attribute specifications and one or more security action codes. Each attribute specification specifies matching values for an attribute. An attribute specification can be set to ‘wildcard’ (denoted with “*”) for all values, or contain a list of values. And for some attributes such as file names and network connection identities, the specification may contain partial ‘wildcard’ for a group of values. For example, an entity attribute of file name may be set to “*.doc” to mean any files with extension name “.doc”; an entity attribute of network connection may be set to {SMTP, *, *, *, *} to specify any connection with the protocol name SMTP, or {TCP, *, *, 100.110.120.130, 80} to specify any connection with protocol name TCP, destination address 100.110.120.130, and destination port number 80. If the specification for an attribute is omitted in a security policy, it is equivalent to set the attribute specification to ‘wildcard’ for all values. A security action code represents a security action to be taken. Following are some security action codes that can be used:

1. PASS_THROUGH, allowing the system activity to be carried out.

2. STOP_ACTIVITY, stopping the system activity.

3. STOP_PROGRAM, stopping the executing software program.

4. LOG_MESSAGE, logging a message to a log file.

5. WARN_WITH_OPTIONS, popping up a window displaying warning message or instructions about the system activity and the software program, and containing optional actions to be chosen by the user. One or more optional action codes are associated with this action code. The optional action code can be any of the action codes described above.

A security policy may contain more than one security action codes that are to be carried out simultaneously, such as STOP_ACTIVITY for stopping a system activity and LOG_MESSAGE for logging a message at the same time.

When the policy execution module receives an attribute array derived from a system activity, it searches for a security policy which attribute specifications best match the attribute array. Each value of the attribute array is compared with the corresponding attribute specification of a security policy. If all attribute values match all attribute specifications of a security policy, the security policy is matched. If there are more than one security policies match the given attribute array, the “narrowest match rule” is applied, that is, the security policy with the narrowest attribute specifications is chosen. An attribute specification is narrower if the range of specified values is smaller. For example, a specific file name is narrower than a file name containing partial ‘wildcard’. It is also desirable in policy design to assign higher priority to certain attribute. For example, the program identity attribute can be assigned higher priority than other attributes. If a security policy has a specific name such as “Microsoft outlook” for its program identity attribute specification, that is, the policy is designed to handle the “Microsoft outlook” program, this security policy would be taken before other security policies for a system activity generated by the “Microsoft outlook” program, provided that the attribute array of the system activity also matches other attribute specifications of this security policy. The effect of attribute priority will be further illustrated in an example presented later.

After finding a security policy, the policy execution module takes the security action specified by the security policy. The security action (WARN_WITH_OPTIONS) will cause a popup window for user to choose the final action. Typically, the final action is either PASS_THROUGH or STOP_ACTIVITY as the system activity is either passed through or stopped. The popup window may also contain option to grant the same operation by the same program without further warning. With reference to FIG. 2, the policy execution module 204 sends a message to the system activity intercept and control module 212 to carry out the final action.

Note that efficient methods of searching for security policies can be applied. Typical methods include using hashing table or tree-based table to reduce searching time. Caching can also be applied, that is, saving a pointer of a found security policy in a table maintained specifically for an executing program, and when the same system activity comprising the same attributes occurs the next time, the security policy can be quickly retrieved from the table. Many efficient searching methods in prior art can be used.

In the preferred embodiment, the policy database may initially contain a set of security policies to prevent potential dangerous software operations conducted by unknown programs without user initiation, and a set of security policies to allow trustworthy programs to conduct well-known software operations with or without user initiation. The user interface module can allow the computer user to browse the policy database, add, delete, or modify any security policies.

Following are a few exemplar security policies. In the following attribute specifications, any attribute that is not specified is a wildcard and can be of any values, and the program identity attribute has a higher priority than other attributes.

Security policy (A)

Attribute specifications:

Program identity: “Microsoft outlook”

Command code: REQUEST_CONNECTION, SEND_DATE, RECEIVE_DATA

Network connection entity: {TCP, *, *, 100.101.102.103, *}

Security action:

PASS_THROUGH and LOG_MESSAGE

Security policy (B)

Attribute specifications:

Program identity: “Microsoft outlook”

Command code: START_PROGRAM, START_COMMAND

Security action:

WARN_WITH_OPTIONS with optional action code STOP_ACTIVITY

Security policy (C)

Attribute specifications:

User Initiation: FALSE

Command code: DELETE_FILE, WRITE_FILE ACCEPT_CONNECTION, REQUEST_CONNECT, START_COMMAND, START_PROGRAM, SET_REGISTRY

Security action:

WARN_WITH_OPTIONS with optional action code: PASS_THROUGH, STOP_ACTIVITY

Security policy (D)

Attribute specifications:

None

Security action:

PASS_THROUGH

Policy (A) allows “Microsoft outlook” program to retrieve emails from mail server of IP address (100.101.102.103) at anytime with or without user initiation. Policy (B) would prevent the “Microsoft outlook” program from executing program or command. Usually, when a user double clicks on an executable program icon attached to an email in “Microsoft outlook” program, the “Microsoft outlook” program would try to execute the program. In such case, a popup window displaying warning message and only one option of STOP_ACTIVITY would appear. Since most recent viruses have spread through email attachments, this policy would not allow executable programs to be executed directly from the “Microsoft outlook” program. The warning message could further explain the potential risk and instruct the user to save the attachment before it can be executed. With policy (C), if the system activity is one of DELETE_FILE, WRITE_FILE, ACCEPT_NETWORK_CONNECTION, REQUEST_NETWORK_CONNECTION, START_COMMAND, START_PROGRAM, SET_REGISTRY and the system activity is not initiated by the user, a warning message window would pop up and allow the user to either pass through or stop the system activity. Policy (D) is a default policy that would pass through any system activity that does not match any other security policies.

Following explains the effect of attribute priority. As mentioned in the above security policies, the program identity attribute has higher priority than other attributes. Suppose the “Microsoft outlook” program has been configured to automatically receive emails from server of IP address (100.101.102.103) every 10 minutes. At the onset of every 10 minutes, the “Microsoft outlook” program would request a network connection to mail server of IP address (100.101.102.103) without user initiation, a system activity would be generated comprising attributes of program identity “Microsoft outlook”, command code REQUEST_CONNECTION, network connection entity (TCP, local-address, local-port, 100.101.102.103, email port number), and user initiation FALSE. This system activity would match both policy (A) and policy (C) described above. The security system would choose policy (A) instead of policy (C), because policy (A)'s program identity attribute has an exact match and the program identity has higher priority than the other attributes.

The above described security policies would prevent malicious software operations without user initiation. However, a specially designed Trojan program could present a misleading user interface and induce the user to operate on it. Once the user operates on the Trojan user interface, the program could immediately conduct malicious operations and avoid detection by the security system as they appear to be initiated by the user. To prevent such operation, a new security policy could be added to warn the user about potentially damaging operation that is conducted the first time by a new program. In the popup window with warning message, the security system could add option allowing the user to grant the same operation by the same program in the future without further warning. If the user chooses to grant the operation in the future, the security system would automatically create a new security policy for such operation by the same program. The following policy (E) would warn the user of any potentially damaging operation by any new program:

Security policy (E)

Attribute specifications:

User initiation: TRUE

Command code: DELETE_FILE, WRITE_FILE ACCEPT_CONNECTION, REQUEST_CONNECT, START_COMMAND, START_PROGRAM, SET_REGISTRY

Security action:

WARN_WITH_OPTIONS with optional action code: PASS_THROUGH, STOP_ACTIVITY, and option to grant the same operation by the same program in the future.

Following takes the popular window program “Windows Explorer” as an example to explain how this security policy works. Suppose the user tries to delete a file in the “Windows Explorer” user interface, a system activity would be generated comprising the attributes of program identity “Windows Explorer”, command code DELETE_FILE, user initiation TRUE. The system activity would match security policy (E), a popup window would appear with options to pass through the operation or deny it, also an option to grant the same operation in the future without further warning. If the user chooses to grant the current and future operation, the security system would pass through the current system activity, and also create a new security policy (F) as shown below:

Security policy (F)

Attribute specifications:

Program identity: “Windows Explorer”

User initiation: TRUE

Command code: DELETE_FILE

Security action:

PASS_THROUGH

If the user subsequently uses the “Windows Explorer” to delete files, the generated system activities would match security policy (F) instead of security policy (E) as the program identity has higher priority, and would pass through without any warning. As it can be seen, security policy (E) provides the user the opportunity to check and stop malicious operations conducted by Trojan programs.

In the above exemplar security policies, for illustration purpose, the program identity uses program name for identification. In another preferred security system, the program identity would use a unique hash value generated from the program file together with program name, especially to identify new program such as the “Windows explorer” in security policy (F). While using the program name in message is preferred for user warning, using a unique hash value will ensure the whole program file is authenticated and has not been modified, preventing Trojan or virus program to fake the program name or insert malicious code into an existing program.

In the security system, the security policy database could comprise one or more files and could be in any file formats. It may be stored locally in the computer, or remotely in a server referred to as the policy server. A policy server can be shared by multiple computers and is desirable in a corporate environment. The security policies may also be comprised in an electronic document that is digitally signed with a digital certificate and sent to the security system. When digitally signed with a certificate, the security policies and the author(s) of the security policies can be authenticated. A public encryption key comprised in the digital certificate can also be used to encrypt data generated by the security system that can be only decrypted by the certificate holder having the private key.

The present invention may be embodied in other specific forms without departing from the spirit or central characteristics thereof. The present embodiments are therefore to be considered in all respects as illustrative and not restrictive.

What is claimed is:

1. A method for protecting a computer from malicious software operation, comprising:
intercepting a system activity;
deriving a user initiation attribute indicating whether or not said system activity is being initiated by a user through at least one peripheral device connected to said computer;
taking a security action regarding said system activity based on information comprising said user initiation attribute;
wherein said system activity is a system operation to be carried out by the computer system on behalf of a software program.

2. The method of claim 1, wherein said security action comprises any of the following actions:
passing through said system activity to be carried out by the operating system;
stopping said system activity before being carried out by the operating system;
popping up a window displaying a message and a plurality of optional actions to be chosen by a computer user, and taking the actions chosen by said computer user;
logging a message in a file;
displaying a message in a window;
generating a sound beep in the computer;
sending an email;
sending a message to a server.

3. The method of claim 2, wherein said system activity comprises any of the following operations:
requesting a network connection;
accepting a network connection;
sending data over a network connection;
receiving data over a network connection.
executing a command;
executing a program;
opening file;
reading data from file;
writing data to file;
deleting file;
renaming file;
closing file;
setting registry key;

4. The method of claim 3, wherein said information comprising said user initiation attribute is a plurality of attributes comprising any of the following additional attributes:
command code representing the operation of said system activity;
one or more identities of computer entities associated with said system activity;
program identity uniquely identifying the software program associated with said system activity;
software vendor identity uniquely identifying the vendor producing the software program associated with said system activity;
whereby additional attributes allow flexible security policy design.

5. The method of claim 1, wherein step of deriving a user initiation attribute further comprises a step of:
setting said user initiation attribute to false meaning said system activity not being initiated by a user if any of the following conditions is true:
no user activity being detected in any of the user controlled peripheral devices connecting to said computer within a time window proceeding said system activity;
the software program associated with said system activity having no user interface for receiving user activity;
wherein said user activity is any of the following data:
keystroke received from a keyboard connected to said computer;
mouse click received from a mouse connected to said computer;
mouse movement received from a mouse connected to said computer;
screen touch received from a touch sensitive screen connected to said computer;
voice command received from a microphone connected to said computer.

6. The method of claim 1, wherein step of deriving a user initiation attribute further comprises steps of:
recording user activities generated in any of the user controlled peripheral devices connecting to said computer;
determining association between said system activity and said user activities.
wherein said user activities comprise any of the following data:
keystroke received from a keyboard connected to said computer;
mouse click received from a mouse connected to said computer;
mouse movement received from a mouse connected to said computer;
screen touch received from a touch sensitive screen connected to said computer;
voice command received from a microphone connected to said computer.

7. The method of claim 6, wherein step of determining association between said system activity and user activities further comprises steps of:
accounting user activities received by the software program associated with said system activity and occurred within a time window proceeding said system activity;
setting said user initiation attribute to true meaning said system activity being initiated by a user if the amount of accounted user activities exceeds a threshold.

8. The method of claim 4, wherein step of taking a security action regarding said system activity based on information of a plurality of attributes further comprises steps of:
searching for a security policy in a plurality of security policies matching said plurality of attributes, wherein each security policy comprises a plurality of attribute specifications and at least one security action, each said attribute specification specifying matching values for an attribute;
taking security action specified by said security policy.

9. The method of claim 8, wherein said plurality of security policies comprises a policy comprising:
attribute specifications comprising:
user initiation attribute specification having value of false meaning not being initiated by a computer user;
command code attribute specification comprising any of the following values:
requesting a network connection;
accepting a network connection;
security action comprising:
popping up window displaying a message and a plurality of optional actions comprising stopping activity and passing through activity to be chosen by a computer user.

10. The method of claim 8, wherein said plurality of security policies comprises a policy comprising security action comprising:
popping up window displaying a message and comprising an option to grant the same operation by the same software program in the future;
wherein said method further comprising a step of creating a new security policy granting said operation by said software program upon said option being chosen by the user.

11. The method of claim 8, wherein said plurality of security policies are stored in any of the following locations:
said computer being protected by said method;
a server connected through a network to said computer being protected by said method.

12. The method of claim 8, wherein said plurality of security policies are comprised in an electronic document comprising a digital signature signed with an digital certificate, said method further comprises a step of:
verifying said digital signature using said digital certificate.

13. A system for protecting a computer from malicious software operation, comprising:
a system activity intercept and control module for intercepting a system activity;
a user association module for deriving a user initiation attribute indicating whether or not said system activity is being initiated by a computer user through at least one peripheral device connected to said computer;
a policy execution module for taking a security action regarding said system activity based on information comprising said user initiation attribute;
wherein said system activity is a system operation to be carried out by the computer system on behalf of a software program.

14. The system of claim 13, wherein said security action comprises any of the following actions:
passing through said system activity to be carried out by the operating system;
stopping said system activity before being carried out by the operating system;
popping up a window displaying a message and a plurality of optional actions to be chosen by a computer user, and taking the actions chosen by said computer user;
logging a message in a file;
displaying a message in a window;
generating a sound beep in the computer;
sending an email;
sending a message to a server.

15. The system of claim 14, wherein said system activity comprises any of the following operations:
requesting a network connection;
accepting a network connection;
sending data over a network connection;
receiving data over a network connection.
executing a command;
executing a program;
opening file;
reading data from file;
writing data to file;
deleting file;
renaming file;
closing file;
setting registry key;

16. The system of claim 15, wherein in said policy execution module said information comprising said user initiation attribute is a plurality of attributes comprising any of the following additional attributes:
command code representing the operation of said system activity;
one or more identities of computer entities associated with said system activity;
program identity uniquely identifying the software program associated with said system activity;
software vendor identity uniquely identifying the vendor producing the software program associated with said system activity;
whereby additional attributes allow flexible security policy design.

17. The system of claim 13, wherein said user association module for deriving a user initiation attribute is further configured to set said user initiation attribute to false meaning said system activity not being initiated by a computer user if any of the following conditions is true:
no user activity being detected in any of the user controlled peripheral devices connecting to said computer within a time window proceeding said system activity;
the software program associated with said system activity having no user interface for receiving user activity;
wherein said user activity is any of the following data:
keystroke received from a keyboard connected to said computer;
mouse click received from a mouse connected to said computer;
mouse movement received from a mouse connected to said computer;
screen touch received from a touch sensitive screen connected to said computer;
voice command received from a microphone connected to said computer.

18. The system of claim 13, wherein said user association module for deriving a user initiation attribute is further configured to perform the following functions:
recording user activities generated in any of the user controlled peripheral devices connecting to said computer;
determining association between said system activity and said user activities.
wherein said user activities comprise any of the following data:
keystroke received from a keyboard connected to said computer;
mouse click received from a mouse connected to said computer;
mouse movement received from a mouse connected to said computer;
screen touch received from a touch sensitive screen connected to said computer;
voice command received from a microphone connected to said computer.

19. The system of claim 18, wherein said user association module for deriving a user initiation attribute is further configured to perform the following functions:
accounting user activities received by the software program associated with said system activity and occurred within a time window proceeding said system activity;
setting said user initiation attribute to true meaning said system activity is initiated by a computer user if the amount of accounted user activities exceeds a threshold.

20. The system of claim 16, wherein said policy execution module is further configured to perform the following functions:
searching for a security policy in a plurality of security policies matching said plurality of attributes, wherein each security policy comprises a plurality of attribute specifications and at least one security action, each said attribute specification specifying matching values for an attribute;
taking security action specified by said security policy.

21. The system of claim 20, wherein said plurality of security policies comprises a policy comprising:
attribute specifications comprising:
user initiation attribute specification having value of false meaning not being initiated by a computer user;
command code attribute specification comprising any of the following values:
requesting a network connection;
accepting a network connection;
security action comprising:
popping up window displaying a message and a plurality of optional actions comprising stopping system activity and passing through system activity, wherein said optional actions can be chosen by a computer user.

22. The system of claim 20, wherein said plurality of security policies comprises a policy comprising security action comprising:
popping up window displaying a message and comprising an option to grant the same operation by the same software program in the future;
wherein said policy execution module is further configured to create a new security policy granting said operation by said software program upon said option being chosen by the user.

23. The system of claim 20, wherein said plurality of security policies are stored in any of the following locations:
said computer being protected by said method;
a server connected through a network to said computer being protected by said method.

24. The system of claim 20, wherein said plurality of security policies are comprised in an electronic document comprising a digital signature signed with an digital certificate, said system further comprises a signature verification module being configured to verify said digital signature using said digital certificate.
